(19) United States
(12) Patent Application Publication
(10) Pub. No.: US 2012/0064334 A1
(43) Pub. Date: Mar. 15, 2012

(54) SOUND-ABSORBING HEAT SHIELD

(75) Inventor: Martin Klautke, Hemer (DE)

(73) Assignee: LYDALL GERHARDI GMBH & CO. KG, Meinerzhagen (DE)

(21) Appl. No.: 13/320,365

(22) PCT Filed: May 14, 2010
(86) PCT No.: PCT/DE10/00527

§ 371 Date: Nov. 14, 2011

(30) Foreign Application Priority Data
May 16, 2009 (DE) 10 2009 021 621.9

(51) Int. Cl. B32B 3/00; B32B 37/14; B32B 37/02; B32B 15/04; B32B 15/08

(52) U.S. Cl. 428/332; 428/457; 428/461; 428/450; 156/196

(57) ABSTRACT

A sound-absorbing heat shield includes at least three layers which are connected to one another. The heat shield is produced from a composite foil which includes two metal foils which are connected to one another via a damping layer. A method for producing a sound-absorbing heat shield introduces a damping layer between two metal foils, subsequently applies pressure to them over their full area, and afterward forms the foil into the desired shape of the heat shield.

The invention relates to a sound-absorbing heat shield according to claim 1. The invention furthermore relates to a method for the production of a sound-absorbing heat shield according to claim 10.

Such heat shields are particularly used in the automotive industry, for example in order to line the tunnel interior in the bottom part of a vehicle. Such linings have great importance, because on the one hand, when catalysts are used, which is usual, the temperature of the exhaust gases and thus also the temperature of the exhaust pipes is greatly elevated, and, on the other hand, the limit values for the noise level of a vehicle must increasingly be set lower.

Currently known sound-absorbing heat shields can be divided into two categories: “Multi-layer absorbers” are formed from multiple foils disposed one behind the other, between which narrow air gaps are disposed. These absorbers have only a slight sound-absorbing effect, due to their low thickness. The so-called “tuned resonant absorbers” consist essentially of a perforated sheet-metal support, behind which a layer consisting of porous medium is disposed. An air gap is disposed between the sheet-metal support and the porous medium.

It is a problem of the previously known heat shields that they are often put into natural vibration, thereby themselves becoming a sound source. Furthermore, there is the risk of vibration cracks.

This is where the invention wishes to provide a remedy. The invention is based on the task of creating a sound-absorbing heat shield that demonstrates great inherent damping and in which vibration cracks are avoided. According to the invention, this task is accomplished by means of the characteristics of claim 1.

With the invention, a sound-absorbing heat shield is created, which demonstrates great inherent damping and in which vibration cracks are avoided. A good damping effect is achieved by means of the use of a composite foil that is formed from two metal foils that are connected with one another over their full area, by way of a damping layer. The present composite foil can be formed into the shape of the heat shield directly.

Preferably, the metal foils of the composite foil are aluminum foils. This material has proven itself in the production of heat shields.

In a further embodiment of the invention, the damping layer of the composite foil is configured as a pressure-sensitive adhesive. In this way, a homogeneous damping layer is achieved over the area of the composite foil.

Preferably, the damping layer has a thickness of 10 μm-150 μm. It is advantageous if the thickness of a metal layer amounts to between 100 μm and 700 μm. Good results were achieved in these ranges with regard to workability of the composite foil as well as the heat-absorbing and sound-absorbing effect of the heat shield produced from the composite foil.

Furthermore, a method for the production of a sound-absorbing heat shield, having the characteristics of claim 10, is an object of the invention. Subsequent forming of the heat shield is simplified by means of combining two metal foils and a damping layer disposed between them, to produce a composite foil.

Last but not least, use of a composite foil for the production of a sound-absorbing heat shield, according to claim 11, is an object of the present invention.

Other further developments and embodiments of the invention are indicated in the other dependent claims.

The heat shield selected as an exemplary embodiment consists essentially of a composite foil that is formed from two metal foils, between which a damping layer is introduced. In the exemplary embodiment, the metal foils have a thickness of 0.3 mm, and the thickness of the damping layer amounts to 0.1 mm. This results in a total foil thickness of 0.7 mm. The two metal layers can also be configured with the same thickness, thereby bringing about a symmetrical structure.

In the exemplary embodiment, the damping layer is configured as a polyethylene-polypropylene-acrylic-silicate layer. This layer forms a pressure-sensitive adhesive that is introduced, in the hot state, between the aluminum foils during the course of production of the composite foil. Subsequently, pressure is applied to the three layers, over their full area, thereby producing the bond between the layers. The composite foil formed in this manner can be used in temperature ranges up to 400 degrees Celsius. The production of the heat shield takes place by means of forming this composite foil into the desired shape.

Resonance vibrations can be clearly reduced and vibration cracks can be avoided by means of the use of the composite foil as described for the production of heat shields. At the same time, production of the heat shields in mass production is clearly facilitated.

1. Sound-absorbing heat shield, comprising at least three layers that are connected with one another, wherein the heat shield is produced from a composite foil that comprises two metal foils that are connected with one another over their full area, by way of a damping layer.

2. Heat shield according to claim 1, wherein the metal foils are aluminum foils.

3. Heat shield according to claim 1, wherein the damping layer is configured as a pressure-sensitive adhesive.

4. Heat shield according to claim 3, wherein the damping layer is a polyethylene-based layer.

5. Heat shield according to claim 4, wherein the damping layer contains polypropylene.

6. Heat shield according to claim 4, wherein the damping layer contains a silicate.

7. Heat shield according to claim 4, wherein the damping layer contains an acrylic.

8. Heat shield according to claim 1, wherein the damping layer has a thickness of 10 μm-150 μm.

9. Heat shield according to claim 1, wherein the thickness of a metal layer amounts to between 100 μm and 700 μm.

10. Method for the production of a sound-absorbing heat shield, in which a composite foil according to claim 1 is produced, wherein the damping layer is introduced between the two metal foils, and subsequently the three layers have pressure applied to them, over their full area, and afterward, the foil is formed into the desired shape of the heat shield.

11. Use of a composite foil according to claim 1 for the production of a sound-absorbing heat shield.
